(19) United States
(12) Patent Application Publication
(10) Pub. No.: US 2021/0017341 A1
(43) Pub. Date: Jan. 21, 2021

(54) HYPERBRANCHED POLYETHERS AND THEIR USE, ESPECIALLY AS POUR POINT DEPRESSANT AND WAX INHIBITORS

(71) Applicant: BASF SE, Luswigshafen an Rhein (DE)

(72) Inventors: Jean-Pierre Berkan LINDNER, Ludwigshafen am Rhein (DE); Edward BOHRES, Ludwigshafen am Rhein (DE); Stefan FRENZEL, Ludwigshafen am Rhein (DE); Radoslaw KIERAT, Ludwigshafen am Rhein (DE)

(21) Appl. No.: 17/042,212

(22) PCT Filed: Mar. 22, 2019
(86) PCT No.: PCT/EP2019/057327

§ 371 Date: Sep. 28, 2020

(30) Foreign Application Priority Data
Mar. 26, 2018 (EP) 18163935.2

(51) Int. Cl. C08G 83/00; C10M 145/38; C08L 71/02

(52) U.S. Cl. CPC C08G 83/006; C10M 145/38; C10L 10/14; C10M 2209/103; C08L 71/02

(57) ABSTRACT

The present invention relates to a hyperbranched polyether of formula (I) RₘQₙ-0-R¹ (I), wherein Q is a branching unit of formula, n is 2^{k}−1, m is 2^{k}, k is 2, 3, 4, 5 or 6, each R is independently a hydrocarbon radical having at least 10 carbon atoms, R¹ is a polymer having a number average molecular weight Mₙ of at least 250 g/mol, wherein each branching unit Q is connected via ether linkage to adjacent branching units Q and each terminal oxygen of Q, not connected to adjacent branching units Q, is connected to R via ether linkage, as well as mixtures thereof. The present invention further relates to formulations comprising said hyperbranched polyether or mixture of ethers as well as their use.

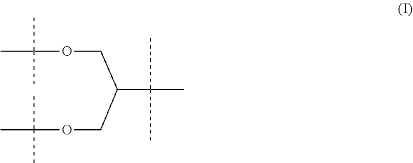

The present invention relates to a hyperbranched polyether as well as mixtures thereof. The present invention further relates to formulations comprising said hyperbranched polyether or mixture of ethers as well as their use.

Underground mineral oil formations typically have relatively high temperatures. After the production of the crude oil to the surface, the crude oil produced therefore cools down to a greater or lesser degree according to the production temperature and the storage or transport conditions.

According to their origin, crude oils have different proportions of waxes, which consist essentially of long-chain n-paraffins. According to the type of crude oil, the proportion of such paraffins may typically be 1 to 30% by weight of the crude oil. When the temperature goes below a particular level in the course of cooling, the paraffins can crystallize, typically in the form of plate-lets. The precipitated paraffins considerably impair the flowability of the oil. The platelet-shaped n-paraffin crystals can form a kind of house-of-cards structure which encloses the crude oil, such that the crude oil ceases to flow, even though the predominant portion is still liquid. The lowest temperature at which a sample of an oil still just flows in the course of cooling is referred to as the “pour point”. For the measurement of the pour point, standardized test methods are used. Precipitated paraffins can block filters, pumps, pipelines and other installations or be deposited in tanks, thus entailing a high level of cleaning.

The deposit temperature of oil deposits is generally above room temperature, for example 40° C. to 100° C. Crude oil is produced from such deposits while still warm, and it naturally cools more or less quickly to room temperature in the course of or after production, or else to lower temperatures under corresponding climatic conditions. Crude oils may have pour points above room temperature, so such that crude oils of this kind may solidify in the course of or after production.

Even if the oil does not cool to room temperature paraffins may deposit on surfaces in contact with the oil, such as surfaces of oil pipelines if the temperature of such surfaces is too low.

It is known that the pour point of crude oils can be lowered by suitable additives. This can prevent paraffins from precipitating in the course of cooling of produced crude oil. Suitable additives firstly prevent the formation of said house-of-cards-like structures and thus lower the temperature at which the crude oil solidifies. In addition, additives can promote the formation of fine, well-crystallized, non-agglomerating paraffin crystals, such that undisrupted oil transport is ensured. Such additives are referred to as pour point depressants or flow improvers.

It is also known to use suitable additives which prevent paraffins from precipitating on surfaces. Such inhibitors are also known as wax inhibitors. Often, an additive may serve both purposes, i.e. preventing paraffins from precipitating on surfaces and diminishing the pour point of crude oils.

GB 900,202 A, GB 1,147,904 A, GB 1,403,782 A and EP 003 489 A1 describe the use copolymers of ethylene and vinyl acetate as pour point depressant for improving cold flow properties of crude oil and mineral oil products.

EP 486 836 A1, U.S. Pat. No. 4,608,411 A, WO 2014/095412 A1 and WO 2014/095408 A1 describe modifications of ethylene-vinyl acetate copolymers by copolymerizing acrylates, in particular long-chain acrylates in the presence of ethylene-vinyl acetate copolymers thereby yielding graft polymers in which at least a part of the polyacrylate has been grafted onto the ethylene-vinyl acetate copolymer.

Boltorn® based hyperbranched polyesters as flow improvers are described in DE 10 2004 014 080 A1.

The additives on basis of (grafted) ethylene-vinyl acetate copolymers (EVA) have good performance, however they are relatively expensive. It is therefore interesting to provide additives which have a similar performance compared to EVA copolymers but which are cheaper. In addition there is an ongoing interest for solutions of additives having a high concentration but which are nevertheless stable at low temperatures.

Thus, even though wax inhibitors/flow improvers/pour point depressants are known in the art there is a need for improved additives that can be readily prepared and are easy to adjust for a specific type of oil with low costs and high stability even in high concentrations.

Accordingly, an object of the present invention is to provide such additives that are easy, flexible and cost-effective to produce.

The object is achieved by a hyperbranched polyether of formula (I)

RₘQₙ-O—R¹ (I),

wherein

Q is a branching unit of formula

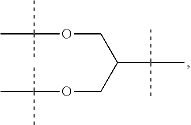

wherein the dashed lines indicate the connectivity to the rest of the molecule,

n is 2^{k}−1,

m is 2^{k},

k is 2, 3, 4, 5 or 6, preferably 2 or 3, more preferably 2,

each R is independently a hydrocarbon radical having at least 10 carbon atoms,

R¹ is a polymer having a number average molecular weight Mₙ of at least 250 g/mol,

wherein each branching unit Q is connected via ether linkage to adjacent branching units Q and each terminal oxygen of Q, not connected to adjacent branching units Q, is connected to R via ether linkage;

or a mixture of two or more of the hyperbranched polyethers of the present invention.

Another aspect of the present inventions is a formulation comprising the hyperbranched polyether of the present invention or a mixture of the present invention and a solvent.

Yet another aspect of the present invention is the use of a hyperbranched polyether of the present invention or a mixture of the present invention as wax inhibitor, as pour point depressant, as lubricant or in lubricating oils.

Surprisingly it has been found that the hyperbranched polyethers of the present invention can be readily prepared and are easy to adjust for a specific type of oil with low costs and high stability even in high concentrations.

A hyperbranched polyether (or a mixture of polyethers) of the present invention is (are) represented by the formula (I):

RₘQₙ-O—R¹ (I).

The variable Q represents the branching unit in order to build up the dendritic glycerol-based hyperbranched polyether molecule. The term “hyperbranched” according to the present invention means that the branching unit comprises a branching point (a secondary carbon atom) and that the molecule has at least 3 branching units. The term “poly”ether refers to a multitude of at least six ether (—O—) functionalities in the molecule.

The variable k indicates the number (m) of residues R and number (n) of branching units Q. The variable k can have the values 2, 3, 4, 5 or 6; n is 2^{k}−1, m is 2^{k}. Accordingly, m is 4, 8, 16, 32 or 64 and n is 3, 7, 15, 31 or 63.

Q is represented by the formula

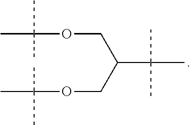

Each branching unit Q is connected via ether linkage to adjacent branching units Q and each terminal oxygen of Q, not connected to adjacent branching units Q, is connected to R via ether linkage.

In case k is 2, the polyether has a first Q, where each oxygen of said first Q is connected via ether functionality to second Q's (in total two second Q's) with each oxygen connected with R via ether functionality (in total 4 R's), and where the remaining connectivity of the first Q is attached to OR¹ resulting in the structure:

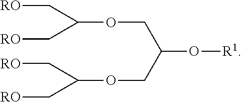

In case k is 3, the polyether has a first Q, where each oxygen of said first Q is connected via ether functionality to second Q's (in total two second Q's), where each oxygen of the two second Q's is connected via ether functionality to third Q's (in total four third Q's), with each oxygen connected with R via ether functionality (in total 8 R's), and where the remaining connectivity of the first Q is attached to OR¹ resulting in the structure:

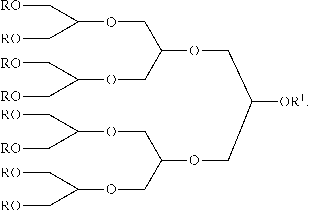

The cases, where k is 4, 5 or 6 can be considered analogously.

The residue R represents a hydrocarbon radical having at least 10 carbon atoms. Each R can be the same or different. Preferably, the number of carbon atoms is from 10 to 48 carbon atoms, more preferably from 10 to 36 carbon atoms, even more preferably from 12 to 34 carbon atoms, even more preferably from 14 to 32 carbon atoms, even more preferably from 16 to 30 carbon atoms, even more preferably from 16 to 28 carbon atoms, even more preferably from 18 to 28 carbon atoms. In case R groups are present in the molecule with different number of carbon atoms, it is preferred that the carbon atom number most often represented is 18, 20, 22, 24, 26, or 28; more preferred is 20, 22 or 24, even more preferred is 22. In general it is preferred that only even-numbered carbon atom numbers are represented.

The residue R is a hydrocarbon radical. The residue R can be cyclic or acyclic or acyclic and cyclic. However it is preferred that the residue R is acyclic. The residue R can be saturated or unsaturated. However, it is preferred that the residue R is saturated. The residue R can be branched or unbranched. However it is preferred that the residue R is unbranched. Accordingly in a more preferred embodiment the residue R is an alkyl group, more preferably an unbranched alkyl, even more preferably an unbranched alk-1-yl group.

Even more preferably, the residues R's are different and represent a mixture of unbranched, Even-numbered alk-1-yl residues with 18 to 28 carbon atoms, preferably with a distribution of up to 1 wt.-% C₁₈, up to 10.0 wt.-% C₂₀, (55.0±10) wt.-% C₂₂, (25.0±6) wt.-% C₂₄, (13.0±4) wt.-% C₂₆ and up to 9.0 wt.-% C₂₈ based on the respective alcohol mixture. Such mixtures are known from respective alcohols commercially available as NAFOL®22+, Sasol.

The residue R¹ is a polymer having a number average molecular weight Mₙ of at least 250 g/mol. The molecular weight can be determined by gel permeation chromatography, e.g. in THE. The term “polymer” as used herein in connection with the residue R¹ refers to a monomeric residue mainly built-up by at least two repeating units. Preferably, R¹ comprises 5 to 200, more preferably 10 to 150 repeating units.

The term “mainly” means that preferably at least 50 mol-%, more preferably at least 60 mol-%, even more preferably at least 70 mol-%, even more preferably at least 80 mol-%, even more preferably at least 90 mol-%, even more preferably at least 95 mol-%, even more preferably at least 99 mol-% of the residue R¹ is represented by the repeating units, based on the total molecular weight of R¹. Preferably, R¹ is a polymer having a number average molecular weight Mₙ in the range from 250 g/mol to 20000 g/mol, preferably from 250 g/mol to 15000 g/mol, even more preferably from 300 g/mol to 15000 g/mol, even more preferably from 300 g/mol to 10000 g/mol, even more preferably, from 400 g/mol to 10000 g/mol, even more preferably, from 400 g/mol to 8000 g/mol, even more preferably from 500 g/mol to 6000 g/mol.

Preferably, R¹ is connected to the oxygen in formula (I) via ester or carbamate group.

Preferably, R¹ comprises an alkylene chain of at least 10 chain carbon atoms, more preferably at least 20 carbon atoms. In case R¹ comprises an alkylene chain of at least 10 chain carbon atoms, preferred number average molecular weights are from 300 g/mol to 15000 g/mol, more preferably, from 400 g/mol to 10000 g/mol, even more preferably, from 500 g/mol to 5000 g/mol, even more preferably, from 700 g/mol to 2.000 g/mol.

More preferably, R¹ comprises —CH₂C(CH₃)₂— repeating units.

Preferably, R¹ comprises alkyleneoxy repeating units. In case R¹ comprises alkyleneoxy repeating units preferred number average molecular weight is from 250 g/mol to 15000 g/mol, more preferably, from 300 g/mol to 10000 g/mol, even more preferably, from 400 g/mol to 8000 g/mol, even more preferably, from 500 g/mol to 6000 g/mol.

More preferably, R¹ comprises ethyleneoxy and/or propyleneoxy repeating units.

In a preferred embodiment the residue R¹ in the hyperbranched polyether of the present invention results from reaction of PIB (polyisobutylene) derivatives, specifically PIBSA (polyisobutylene succinic anhydride), for example PIBSA 1000 and furthermore polyisocyanates obtainable by reaction of said non-polar dendrons with a diisocyanate and polyethylene glycols and/or polypropylene glycols (Pluriol® compounds).

The present invention also relates to mixtures of hyperbranched polyethers. Such mixtures comprise at least one polyether of formula (I). Typically such mixtures comprise more than only one polyether of formula (I) and can comprise further polyethers other than polyethers of formula (I). The composition of such mixture mainly depends on the preparation route.

Typically, the synthesis starts with an alcohol or alcohols R—OH reacting with glycerine or preferably activated glycerine derivatives such as epichlorhydrine thereby yielding a dendritic structure that is reacted in a second stage to further modify the polyether precursor by introducing R¹. The built-up of the hyperbranched structures of this type is known in the art and described, e.g. in WO 2010/000713 A1, WO 2012/029038 A1 and in A. Richter et al., European Journal of Pharmaceutical Sciences 40 (2010) 48-55.

Accordingly, the mixtures of the present invention can result from the use of alcohol mixtures as starting material, an incomplete ether formation resulting in free alcohol functions, only a partial reaction of glycerine or activated glycerine derivative (lower value for variable n and m, respectively) and the like.

Use of the Hyperbranched Polyether (Mixture)

Use as Wax Inhibitor

In one embodiment of the invention, the above-detailed hyperbranched polyether (mixture), are used to prevent wax deposits on surfaces in contact with, e.g., crude oil, mineral oil and/or mineral oil products, preferably for surfaces in contact with crude oil. The use is effected by adding at least one of the above-detailed hyperbranched polyether (mixture) to the crude oil, mineral oil and/or mineral oil products.

Accordingly one aspect of the present invention is the use of a hyperbranched polyether (mixture) of the present invention as wax inhibitor.

Thus another aspect of the invention is a method for the prevention of wax deposits on surfaces, comprising the step of adding a hyperbranched polyether (mixture) of the present invention to crude oil, mineral oil and/or mineral oil products.

For the inventive use, the hyperbranched polyether (mixture) can be used as such. Preference is given, however, to using formulations of the hyperbranched polyether (mixture) in suitable solvents which may comprise further components as well as the solvents. Examples of suitable solvents comprise hydrocarbons, in particular hydrocarbons having a boiling point of more than 110° C. Examples of such solvents comprise toluene, xylenes, or technical mixtures of high boiling aromatic solvents.

The concentration of an appropriate formulation may, for example, be 10 to 50% by weight, preferably 25 to 40% by weight of hyperbranched polyether (mixture) prepared in accordance with the invention and optionally further components except for the solvents, this figure being based on the total amount of all components including the solvents. While the formulations are naturally produced in a chemical plant, the ready-to-use formulation can advantageously be produced on site, i.e., for example, directly at a production site for oil.

Thus another aspect of the present invention is a formulation comprising the hyperbranched polyether (mixture) of the present invention and a solvent.

The hyperbranched polyether (mixture) or formulations thereof are typically used in such an amount that the amount of the hyperbranched polyether (mixture) added is 50 to 3,000 ppm based on the oil. The amount is preferably 100 to 1,500 ppm, more preferably 250 to 600 ppm and, for example, 300 to 1,000 ppm. The amounts are based on the hyperbranched polyether (mixture) itself, not including any solvents present and optional further components of the formulation. The formulation of the hyperbranched polyether (mixture) in suitable solvents may comprise further components.

In a preferred embodiment of the invention, the oil is crude oil and the formulation is injected into a crude oil pipeline. The injection can preferably be effected at the oilfield, i.e. at the start of the crude oil pipeline, but the injection can of course also be effected at another site. More particularly, the pipeline may be one leading onshore from an offshore platform, especially when the pipelines are in cold water, for example having a water temperature of less than 10° C., i.e. the pipelines have cold surfaces.

In a further embodiment of the invention, the oil is crude oil and the formulation is injected into a production well. Here too, the production well may especially be a production well leading to an offshore platform. The injection is preferably effected approximately at the site where oil from the formation flows into the production well. In this way, the deposition of paraffins on surfaces can be prevented.

Use as Pour Point Depressants

The hyperbranched polyether (mixture) of the present invention may be used as pour point depressants for crude oil, mineral oil and/or mineral oil products, preferably as pour point depressant for crude oil by adding at least one of the hyperbranched polyether (mixture) detailed above to the crude oil, mineral oil and/or mineral oil products.

Thus another aspect of the present invention is the use of a hyperbranched polyether (mixture) of the present invention as pour point depressant.

Thus another aspect of the present invention is a method of reducing the pour point comprising the step of adding a hyperbranched polyether (mixture) of the present invention to crude oil, mineral oil and/or mineral oil products.

Pour point depressants reduce the pour point of crude oils, mineral oils and/or mineral oil products. The pour point (“yield point”) refers to the lowest temperature at which a sample of an oil, in the course of cooling, still just flows. For the measurement of the pour point, standardized test methods are used. Preferred formulations have already been mentioned, and the manner of use is also analogous to the use as a wax inhibitor.

For use as pour point depressant, the formulation of the crude oil, mineral oil and/or mineral oil products in suitable solvents may comprise further components. For example, additional wax dispersants can be added to the formulation. Wax dispersants stabilize paraffin crystals which have formed and prevent them from sedimenting. The wax dispersants used may, for example, be alkylphenols, alkylphenol-formaldehyde resins or dodecylbenzenesulfonic acid.

Use in Lubricating Oils

The present invention is also directed to the use of the hyperbranched polyether (mixture) in lubricating oils by mixing (a) at least one base oil component, (b) the hyperbranched polyether (mixture) as defined herein, and (c) optionally other additives.

Thus another aspect of the present invention is the use of a hyperbranched polyether (mixture) of the present invention in lubricating oils.

Thus another aspect of the present invention is a method for preparing lubricating oil comprising the step of mixing (a) at least one base oil component, (b) the hyperbranched polyether (mixture) as defined herein, and (c) optionally other additives.

It furthermore relates to lubricating oil compositions comprising the crude oil, mineral oil and/or mineral oil products according to the present invention.

The lubricating oil compositions may comprise the following components:

(a) at least one base oil component,

(b) hyperbranched polyether (mixture) as defined herein, and

(c) optionally other additives.

For making the lubricating oil compositions the hyperbranched polyether (mixture) may be used as such. In an alternative embodiment a concentrate composition for use in lubrication oils comprising

(i) a diluent, and

(ii) from 30 to 70% by weight of the hyperbranched polyether (mixture) may be used.

The amounts of the hyperbranched polyether (mixture) of the present invention, the base oil component and the optional additive in the lubricating oil compositions are generally as follows:

In the most generic embodiment the amounts are from 0.1 to 30 weight percent of the hyperbranched polyether (mixture), from 70 to 99.9 weight percent base oil, and, from 0.05 to 10 weight percent of additives.

Preferably, the amounts are from 0.5 to 25.0 weight percent of the hyperbranched polyether (mixture), from 75 to 99.0 weight percent base oil, and, from 0.1 to 20 weight percent of additives.

More preferably, the amounts are from 1.0 to 20.0 weight percent of the hyperbranched polyether (mixture), from 80.0 to 95.0 weight percent base oil, and from 0.5 to 15.0 weight percent of additives.

Most preferably, the amounts are from 1.5 to 15.0 weight percent of the hyperbranched polyether (mixture), from 85.0 to 90.0 weight percent base oil, and from 0.8 to 15.0 weight percent of additives.

The weight ratio of the base oil component to the hyperbranched polyether (mixture) of the present invention in the lubricating oil compositions according to the present invention is generally in the range of from 4 to 1000, more preferably from 5 to 500, even more preferably from 8 to 200, and most preferably from 10 to 150.

In another preferred embodiment of the present invention, the lubricating oil composition contains from about 0.1 to 20.0 parts by weight, preferably 0.2 to about 15.0 parts by weight, and more preferably about 0.5 to about 10.0 parts by weight, of the neat hyperbranched polyether (mixture) (i.e. excluding diluent base oil) per 100 weight of base fluid. The preferred dosage will of course depend upon the base oil.

The lubricating oil compositions according to the present invention include at least one additive which is preferably selected from the group consisting of antioxidants, oxidation inhibitors, corrosion inhibitors, friction modifiers, metal passivators, rust inhibitors, anti-foamants, viscosity index enhancers, additional pour-point depressants, dispersants, detergents, further extreme-pressure agents and/or anti-wear agents.

More preferred additives are described in more detail below.

The lubricating oil compositions according to the present invention are characterized by KRL shear stability as measured by the shear stability index based on DIN 51350-6, CEC L-45-99 mod. (20 h). The present invention has a shear loss less than 5%, preferably less than 3%, and more preferably less than 1% after 20 h.

In addition or alternatively, the lubricating oil compositions according to the present invention further display high viscosity index (VI) as measured by ASTM D2270.

Preferred viscosity index values of the lubricating oil compositions according to the present invention are at least 180, preferably at least 190, more preferably at least 200, even more preferably at least 205, and most preferably at least 210.

Additionally or alternatively, treat rates of the lubricant oil compositions according to the present invention can preferably be in some selected embodiments in the range of from 1.0 to 30.0, preferably from 2.0 to 25.0, more preferably from 2.5 to 15.0 and most preferably from 3.0 to 10.0 weight percent.

In summary, the lubricating oil compositions provide excellent viscosity characteristics at low and high temperatures and when subjected to high shear stress.

Base Oils

Preferred base oils contemplated for use in the lubricating oil compositions according to the present invention include mineral oils, poly-alpha-olefin synthetic oils and mixtures thereof. Suitable base oils also include base stocks obtained by isomerization of synthetic wax and slack wax, as well as base stocks produced by hydrocracking (rather than solvent extracting) the aromatic and polar components of the crude. In general, both the mineral and synthetic base oils will each have a kinematic viscosity ranging from about 1 to about 40 mm²/s at 100 degrees centigrade, although typical applications will require each oil to have a viscosity ranging from about 1 to about 10 mm²/s at 100 degrees centigrade.

The mineral oils useful in this invention include all common mineral oil base stocks. This would include oils that are naphthenic, paraffinic or aromatic in chemical structure. Naphthenic oils are made up of methylene groups arranged in ring formation with paraffinic side chains attached to the rings. The pour point is generally lower than the pour point for paraffinic oils. Paraffinic oils comprise saturated, straight chain or branched hydrocarbons. The straight chain paraffins of high molecular weight raise the pour point of oils and are often removed by dewaxing. Aromatic oils are hydrocarbons of closed carbon rings of a semi-unsaturated character and may have attached side chains.

This oil is more easily degraded than paraffinic and naphthalenic oils leading to corrosive by-products.

In reality a base stock will normally contain a chemical composition which contains some proportion of all three (paraffinic, naphthenic and aromatic). For a discussion of types of base stocks, see Motor Oils and Engine Lubrication by A. Schilling, Scientific Publications, 1968, section 2.2 thru 2.5.

The hyperbranched polyether (mixture) may be used in paraffinic, naphthenic and aromatic type oils. For example, the poly(meth)acrylate copolymer may be used in Groups I-V base oils. These Groups are well known by those skilled in the art. Additionally, the hyperbranched polyether (mixture) may be used in gas to liquid oils.

Gas to liquid oils (GTL) are well known in the art. Gaseous sources include a wide variety of materials such as natural gas, methane, C1-C3 alkanes, landfill gases, and the like. Such gases may be converted to liquid hydrocarbon products suitable for use as lubricant base oils by a gas to liquid (GTL) process, such as the process described in U.S. Pat. No. 6,497,812, the disclosure of which is incorporated herein by reference.

Base oils derived from a gaseous source, hereinafter referred to as “GTL base oils”, typically have a viscosity index of greater than about 130, a sulfur content of less than about 0.3 percent by weight, contain greater than about 90 percent by weight saturated hydrocarbons (isoparaffins), typically from about 95 to about 100 weight percent branched aliphatic hydrocarbons, have a pour point of below −15 to −20 C.

The GTL base oils may be mixed with more conventional base oils such as Groups I to V as specified by API. For example, the base oil component of the lubricant compositions may include 1 to 100 percent by weight to a GTL base oil.

Thus a lubricating oil composition may be at least partially derived from a gaseous source and contain the instant hyperbranched polyether (mixture) as a pour point depressant.

Oils may be refined by conventional methodology using acid, alkali, and clay or other agents such as aluminum chloride, or they may be extracted oils produced, for example, by solvent extraction with solvents such as phenol, sulfur dioxide, furfural, dichlordiethyl ether, etc. They may be hydrotreated or hydrorefined, dewaxed by chilling or catalytic dewaxing processes, or hydrocracked. The mineral oil may be produced from natural crude sources or be composed of isomerized wax materials or residues of other refining processes. The preferred synthetic oils are oligomers of aolefins, particularly oligomers of 1-decene, also known as poly-alphaolefins or PAO's.

The base oils may be derived from refined, re-refined oils, or mixtures thereof.

Unrefined oils are obtained directly from a natural source or synthetic source (e.g., coal, shale, or tar sands bitumen) without further purification or treatment. Examples of unrefined oils include a shale oil obtained directly from a retorting operation, a petroleum oil obtained directly from distillation, or an ester oil obtained directly from an esterification process, each of which is then used without further treatment. Refined oils are similar to the unrefined oils except that refined oils have been treated in one or more purification steps to improve one or more properties. Suitable purification techniques include distillation, hydrotreating, dewaxing, solvent extraction, acid or base extraction, filtration, and percolation, all of which are known to those skilled in the art.

Re-refined oils are obtained by treating used oils in processes similar to those used to obtain the refined oils. These re-refined oils are also known as reclaimed or reprocessed oils and are often additionally processed by techniques for removal of spent additives and oils breakdown products.

Optional Customary Oil Additives

The addition of at least one additional customary oil additive to the lubricating oil compositions of the present invention is possible but not mandatory in every case. The mentioned lubricant compositions, e.g. greases, gear fluids, metal-working fluids and hydraulic fluids, may additionally comprise further additives that are added in order to improve their basic properties still further.

Such additives include: further antioxidants or oxidation inhibitors, corrosion inhibitors, friction modifiers, metal passivators, rust inhibitors, anti-foamants, viscosity index enhancers, additional pour-point depressants, dispersants, detergents, further extreme pressure agents and/or anti-wear agents.

Such additives can be present in the amounts customary for each of them, which range in each case from 0.01 to 10.0 percent by weight, preferably from 0.05 to 3.0 percent by weight, and more preferably from 0.1 to 1.0 percent by weight based on the total weight of the lubricating oil composition. Examples of further additives are given below:

1. Examples of Phenolic Antioxidants:

1.1. Alkylated monophenols: 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-ditert-butyl-4-isobutylphenol, 2,6-dicyclopentyl-4-methylphenol, 2-(alpha-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear nonylphenols or nonylphenols branched in the side chain, such as, for example, 2,6-dinonyl-4-methylphenol, 2,4-dimethyl-6-(1′-methyl-undec-1′-yl)-phenol, 2,4-dimethyl-6-(1′-methylheptadec-1′-yl)-phenol, 2,4-dimethyl-6-(1′-methyltridec-1′-yl)-phenol and mixtures thereof;

1.2. Alkylthiomethylphenols: 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;

1.3. Hydroquinones and alkylated hydroquinones: 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate;

1.4. Tocopherols: alpha-, beta-, gamma or delta-tocopherol and mixtures thereof (like for in-stance vitamin E);

1.5. Hydroxylated thiodiphenyl ethers: 2,2′-thio-bis(6-tert-butyl-4-methylphenol), 2,2′-thio-bis(4-octylphenol), 4,4′-thio-bis(6-tert-butyl-3-methylphenol), 4,4′-thio-bis(6-tertbutyl-2-methylphenol), 4,4′-thio-bis(3,6-di-sec-amylphenol), 4,4′-bis(2,6-dimethyl-4-hydroxy-phenyl)disulfide;

1.6. Alkylidene bisphenols: 2,2′-methylene-bis(6-tert-butyl-4-methylphenol), 2,2′-methylene-bis(6-tert-butyl-4-ethylphenol), 2,2′-methylene-bis[4-methyl-6-(alpha-methylcyclohexyl)phenol], 2,2′-methylene-bis(4-methyl-6-cyclohexylphenol), 2,2′-methylene-bis(6-nonyl-4-methylphenol), 2,2′-methylene-bis(4,6-di-tert-butylphenol),2,2′-ethylidene-bis(4,6-di-tert-butylphenol), 2,2′-ethylidene-bis(6-tert-butyl-4-isobutylphenol), 2,2′-methylene-bis[6-(alpha-methylbenzyl)-4-nonylphenol], 2,2′-methylene-bis[6-(alpha, alpha-dimethyl-benzyl)-4-nonylphenol], 4,4′-methylenebis(2,6-di-tert-butylphenol), 4,4′-methylene-bis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)-butyrate], bis(3-tert-butyl-4-hydroxy-5-methylphenyl)dicyclopentadiene, bis[2-(3′-tertbutyl-2′-hydroxy-5′-methylbenzyl)-6-tert-butyl-4-methylphen yl]terephthalate, 1,1-bis(3,5-dimethyl-2-hydroxyphenyl)butane, 2,2-bis(3,5-di-tert-butyl-4-hydroxyphenyl)-propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane;

1.7. O-. N- and S-benzyl compounds: 3,5,3′,5′-tetra-tert-butyl-4,4′-dihydroxydibenzylether, octa-decyl-4-hydroxy-3,5-dimethylbenzyl-mercaptoacetate, tridecyl-4-hydroxy-3,5-di-tert-butylbenzyl-mercaptoacetate, tris (3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzyl-mercaptoacetate;

1.8. Hydroxybenzylated malonates: dioctadecyl-2,2-bis(3,5-di-tert-butyl-2-hydroxybenzyl)malonate, dioctadecyl-2-(3-tert-butyl-4-hydroxy-5-methylbenzyl)malonate, di-dodecyl-mercaptoethyl-2,2-bis(3,5-di-tert-butyl-4-hydroxybenzyl) malonate, di[4-(1,1,3,3-tetramethylbutyl)-phenyl]-2,2-bis(3,5-di-tertbutyl-4-hydroxybenzyl)malonate;

1.9. Hydroxybenzyl aromatic compounds: 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;

1.10. Triazine compounds: 2,4-bis-octylmercapto-6-(3,5-di-tert-butyl-4-hydroxyanilino)-1,3,5-triazin e, 2-octylmercapto-4,6-bis(3,5-di-tert-butyl-4-hydroxyanilino)-1,3,5-triazine,2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris (3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate;

1.11. Acylaminophenols: 4-hydroxylauric acid anilide, 4-hydroxystearic acid anilide, N-(3,5-di-tert-butyl-4-hydroxyphenyl)-carbamic acid octyl ester;

1.12. Esters of beta-(5-tert-butyl-4-hydroxy-3-methylphenyl) propionic acid: with polyhydric alcohols, e.g. with 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl) oxalic acid diamide, 3-thiaundecanol, 3-thiapentadecanol, trimethylhexanediol, trimethylolpropane, 4-hydroxymethyl-1-phospha-2,6,7-trioxabicyclo[2.2.2]octane;

1.13. Esters of beta-(3,5-di-tert-butyl-4-hydroxyphenyl) propionic acid, .gamma.-(3,5-dicyclohexyl-4-hydroxyphenyl) propionic acid, 3,5-di-tert-butyl-4-hydroxyphenylacetic acid: with mono- or polyhydric alcohols, e.g. with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-hydroxyethyl oxalic acid diamide, 3-thiaundecanol, 3-thiapentadecanol, trimethylhexanediol, trimethylolpropane, 4-hydroxymethyl-1-phospha-2,6,7-trioxabicyclo[2.2.2]octane;

1.14. Amides of beta-(3,5-di-tert-butyl-4-hydroxyphenyl) propionic acid: N,N′-bis(3,5-ditert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine;

1.15. Ascorbic acid (vitamin C);

1.16. Aminic antioxidants: N,N′-diisopropyl-p-phenylenediamine, N,N′-di-sec-butyl-pphenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′dicyclohexyl-p-phenylenediamine, N,N′-diphenyl-p-phenylenediamine, N,N′-di(naphth-2-yl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-pphenylenediamine, N-cyclohexyl-N′-phenyl-p-phenylenediamine, 4-(ptoluenesulfonamido)-diphenylamine, N,N′-dimethyl-N,N′-di-sec-butyl-pphenylenediamine, diphenylamine, N-allyldiphenylamine, 4-isopropoxydiphenylamine, 4-n-butylaminophenol, 4-butyrylaminophenol, 4-nonanoylaminophenol, 4-dodecanoylaminophenol, 4-octadecanoylaminophenol, di(4-methoxyphenyl)amine, 2,6-di-tert-butyl-4-dimethylaminomethyl phenol, 2,4′-diaminodiphenylmethane, 4,4′-diaminodiphenylmethane, N,N,N′,N′-tetramethyl-4,4′-diaminodiphenylmethane, 1,2-di[(2-methylphenyl)amino]-ethane, 1,2-di(phenylamino)propane, (o-tolyl)biguanide, di[4-(1′,3′-dimethylbutyl)phenyl]amine, tert-octylated N-phenyl-1-naphthylamine, mixture of mono- and di-alkylated tert-butyl/tert-octyl-diphenylamines, mixture of mono- and di-alkylated nonyidiphenyl-amines, mixture of mono- and di-alkylated dodecyldiphenylamines, mixture of mono- and di-alkylated isopropyl/isohexyldiphenylamines, mixtures of mono- and di-alkylated tert-butyldiphenylamines, 2,3-dihydro-3,3-dimethyl-4H-1,4-benzothiazine, phenothiazine, mixture of mono- and dialkylated tert-butyl/tert-octyl-phenothiazines, mixtures of mono- and di-alkylated tertoctylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl)sebacate, 2,2,6,6-tetramethylpiperidin-4-one, 2,2,6,6-tetramethylpiperidin-4-ol.

2. Examples of further antioxidants: aliphatic or aromatic phosphites, esters of thiodipropionic acid or thiodiacetic acid or salts of dithiocarbamic acid, 2,2,12,12-tetramethyl-5,9-dihydroxy-3,7,11-trithiamidecane and 2,2,15,15-tetramethyl-5,12-dihydroxy-3,7, 10,14-tetrathiahexadecane.

3. Examples of Metal Deactivators. e.g. for Copper:

3.1. Benzotriazoles and derivatives thereof: 2-mercaptobenzotriazole, 2,5-dimercaptobenzotriazole, 4- or 5-alkylbenzotriazoles (e.g. tolutriazole) and derivatives thereof, 4,5,6,7-tetrahydrobenzotriazole, 5,5′-methylene-bis-benzotriazole; Mannich bases of benzotriazole or tolutriazole, such as 1-[di(2-ethylhexyl)aminomethyl]tolutriazole and 1-[di(2-ethylhexyl)aminomethyl]benzotriazole; alkoxyalkylbenzotriazoles, such as 1-(nonyloxy-methyl)benzotriazole, 1-(1-butoxyethyl)-benzotriazole and 1-(1-cyclohexyloxybutyl)-tolutriazole;

3.2. 1,2,4-Triazoles and derivatives thereof: 3-alkyl-(or -aryl-) 1,2,4-triazoles, Mannich bases of 1,2,4-triazoles, such as 1-[di(2-ethylhexyl)aminomethyl]-1,2,4-triazole; alkoxyalkyl-1,2,4-triazoles, such as 1-(1-butoxyethyl)-1,2,4-triazole; acylated 3-amino-1,2,4-triazoles;

3.3. Imidazole derivatives: 4,4′-methylene-bis(2-undecyl-5-methyl) imidazole and bis[(N-methyl)imidazol-2-yl]carbinol-octyl ether;

3.4. Sulfur-containing heterocyclic compounds: 2-mercaptobenzothiazole, 2,5-dimercapto-1,3,4-thiadiazole, 2,5-dimercaptobenzothiadiazole and derivatives thereof; 3,5-bis[di(2-ethylhexyl)aminomethyl]-1,3,4-thiadiazolin-2-one;

3.5. Amino compounds: salicylidene-propylenediamine, salicylaminoguanidine and salts thereof.

4. Examples of Rust Inhibitors:

4.1. Organic acids, their esters, metal salts, amine salts and anhydrides: alkyl- and alkenylsuc-cinic acids and their partial esters with alcohols, diols or hydroxycarboxylic acids, partial amides of alkyl- and alkenyl-succinic acids, 4-nonylphenoxyacetic acid, alkoxy- and alkoxyethoxy-carboxylic acids, such as dodecyloxyacetic acid, dodecyloxy (ethoxy)acetic acid and amine salts thereof, and also N-oleoyl-sarcosine, sorbitan monooleate, lead naphthenate, alkenylsuc-cinic acid anhydrides, e.g. dodecenylsuccinic acid anhydride, 2-(2-carboxyethyl)-1-dodecyl-3-methylglycerol and salts thereof, especially sodium and triethanolamine salts thereof.

4.2. Nitrogen-containing Compounds:

4.2.1. Tertiary aliphatic or cycloaliphatic amines and amine salts of organic and inorganic acids, e.g. oil-soluble alkylammonium carboxylates, and 1-[N,N-bis(2-hydroxyethyl)amino]-3-(4-nonylphenoxy)propan-2-ol;

4.2.2. Heterocyclic compounds: substituted imidazolines and oxazolines, e.g. 2-heptadecenyl-1-(2-hydroxyethyl)-imidazoline;

4.2.3. Sulfur-containing compounds: barium dinonyinaphthalene sulfonates, calcium petroleum sulfonates, alkylthio-substituted aliphatic carboxylic acids, esters of aliphatic 2-sulfocarboxylic acids and salts thereof.

5. Examples of additional viscosity index enhancers: polyacrylates, polymethacrylates, nitrogen containing polymethylmethacrylates, vinylpyrrolidone/methacrylate copolymers, polyvinylpyrrol-idones, polybutenes, polyisobutylenes, olefin copolymers such as ethylene-propylene copolymers, styrene-isoprene copolymers, hydrated styrene-isoprene copolymers, styrene/acrylate copolymers and polyethers. Multifunctional viscosity improvers, which also have dispersant and/or antioxidancy properties are known and may optionally be used in addition to the products of this invention.

6. Examples of pour-point depressants: polymethacrylates, ethylene/vinyl acetate copolymers, alkyl polystyrenes, fumarate copolymers, alkylated naphthalene derivatives.

7. Examples of dispersants/surfactants: polybutenylsuccinic acid amides or imides, poly-butenylphosphonic acid derivatives, basic magnesium, calcium and barium sulfonates and phenolates.

8. Examples of extreme-pressure and anti-wear additives: sulfur- and halogen containing compounds, e.g. chlorinated paraffins, sulfurized olefins or vegetable oils (soybean oil, rape oil), alkyl- or aryl-di- or -tri-sulfides, benzotriazoles or derivatives thereof, such as bis(2-ethylhexyl)aminomethyl tolutriazoles, dithiocarbamates, such as methylene-bis-dibutyldithiocarbamate, derivatives of 2-mercaptobenzothiazole, such as 1-[N,N-bis(2-ethylhexyl)aminomethyl]-2-mercapto-1H-1,3-benzothiazole, derivatives of 2,5-dimercapto-1,3,4-thiadiazole, such as 2,5-bis(tert-nonyidithio)-1,3,4-thiadiazole.

9. Examples of coefficient of friction reducers: lard oil, oleic acid, tallow, rape oil, sulfurized fats, amides, amines. Further examples are given in EP-A-0 565 487.

10. Examples of special additives for use in water/oil metal-working fluids and hydraulic fluids: Emulsifiers: petroleum sulfonates, amines, such as polyoxyethylated fatty amines, non-ionic surface-active substances; buffers: such as alkanolamines; biocides: triazines, thiazolinones, tris-nitromethane, morpholine, sodium pyridenethiol; processing speed improvers: calcium and barium sulfonates.

The hyperbranched polyether (mixture) according to the present invention is useful as viscosity index improvers in lubricating oil compositions and may be admixed with a base oil and at least one of the above-mentioned additives to form the desired lubricating oil composition. It is also possible to first prepare a concentrate or a so-called “additive pack” comprising the desired spectrum of additives, which can then be subsequently diluted to give the working concentrations for the intended lubricating oil composition.

Lubricating oil compositions containing the hyperbranched polyether (mixture) of the present invention may be used in a number of different applications including automatic transmission fluids, manual transmission fluids, hydraulic fluids, greases, gear fluids, metal-working fluids, crankcase engine oil applications and/or shock absorber fluids.

The hyperbranched polyether (mixture) of the present invention is useful for the preparation of lubricating oil compositions which have special technical performance characteristics.

Most importantly, the rheology profiles at low temperatures, including the temperature dependency of the kinematic viscosity of the lubricating oil compositions of the present invention over a broad temperature range is excellent as derivable from measuring kinematic viscosity at different temperatures.

In summary, the temperature-dependent viscosity profile in combination with the high shear stability of the lubricating oil compositions according to the present invention represents an unusual spectrum of performance characteristics for a lubricating oil composition because these effects normally negatively affect each other.

The present invention is also directed to a method for improving the shear stability of a lubricating oil composition wherein the method comprises the step of providing the hyperbranched polyether (mixture) of the present invention and adding it to a base oil and optional additives to form a lubricating oil composition with improved shear stability. Lubrication oils containing hyperbranched polyether (mixture) of the present invention may be used in automatic transmission fluids, manual transmission fluids, hydraulic fluids, greases, gear fluids, metal-working fluids, engine oil applications and shock absorber fluids.

The invention is illustrated in detail by the examples which follow.

### Examples

Preparations

Fatty alcohols have molecular weight of 463 g/mol, OH-number of 121 mg KOH/g and can be obtained as Nafol 22+ from Sasol. Polyisobutylene-anhydride (PIBSA) has a molecular weight of 1000 g/mol or 500 g/mol and can be obtained from BASF SE (research sample). Polyethylene and Polypropyleneglycols have a molecular weight of 1300 g/mol or 500 g/mol or 6000 g/mol and can be obtained as PLuriol A 6000PE, Pluriol A 500PE or Pluriol A 1350P. Isopho-rone-diisocyanate was obtained from Aldrich chemicals.

Synthesis Nafol 22+-Dendron (D1):

64.4 g powdered sodium hydroxide was added to a solution of 345 g Nafol 22+ in 1060 mL toluene. The reaction mixture was heated to reflux for 6 hours. Next the reaction was cooled down to 100° C. and 64.15 g epichlorohydrine dissolved in 156 mL of toulene were added dropwise over one hour. After completion of the addition the reaction was stirred at 100° C. for 20 hours. 45.0 g Methanol were added and the reaction was stirred under reflux for another two hours. After cooling to room temperature the solvent was removed by vacuum distillation. The residual solid was mixed with 500 mL of water and neutralized with H₂SO₄ at 80° C. Filtration yielded the solid intermediate product.

Sample 1

50 g of D1 were mixed with 30.3 g PIBSA 500. The mixture was heated to 160° C. for 4 hours and 170° C. for 1 hour. After cooling to room temperature a dark solid S1 was obtained.

Sample 2

50 g of D1 were mixed with 60.6 g PIBSA 1000. The mixture was heated to 160° C. for 4 hours and 170° C. for 1 hour. After cooling to room temperature a dark solid S2 was obtained.

Sample 3

50 g of D1 were mixed with 61.4 g PIBSA 1000. The mixture was heated to 160° C. for 4 hours. After cooling to room temperature a dark solid S3 was obtained.

Sample 4

50 g of D1 was dissolved in 60 mL Toluene at 60° C. 13.2 g of Isophorone-diisocyanate were added dropwise (over 10 min) to the solution at 30° C. The reaction was monitored at room temperature until an NCO-value of 3.9% was reached. Afterwards Pluriol A 1350 P was added dropwise. The reaction mixture was stirred for two hours at 80° C., until NCO value of 0% was reached. The solvent was removed under reduced pressure.

Sample 5

50 g of D1 was dissolved in 60 mL Toluene at 60° C. 12.7 g of Isophorone-diisocyanate were added dropwise (over 10 min) to the solution at 30° C. The reaction was stirred for 2 hours at 60° C. Afterwards Pluriol A 500PE was added and the mixture was heated to 95° C. for 4 hours. The solvent was removed under reduced pressure.

Sample 6

25 g of D1 was dissolved in 30 mL Toluene at 60° C. 6.35 g of Isophorone-diisocyanate were added dropwise (over 10 min) to the solution at 30° C. The reaction was stirred for 2 hours at 60° C. Afterwards Pluriol A 6000PE was added and the mixture was heated to 95° C. for 4 hours. The solvent was removed under reduced pressure.

Wax Inhibition

The cold finger deposition test was utilized to determine the wax inhibition properties of the hyperbranched polyethers. The wax inhibition was determined by exposing the crude oil to a cold metal finger surface in the presence and absence of the inhibitor. The amount and type of wax deposited on the cold metal finger was used to determine waxing tendency.

For the tests, a crude oil from the “Landau” oilfield in south-west Germany (Wintershall Holding GmbH) having an API gravity of 37 and a pour point of 21° C. was used. The test was started by conditioning the oil sample by heating to 80° C. and holding for 30 minutes to remove thermal history. A water bath on the cold finger apparatus was adjusted so that the oil temperature is maintained at 30° C. The cold finger was maintained at 15° C. and the cold finger was inserted into oil sample. The test was run for 6 hours. The cold finger was removed the wax deposit was removed with a previous weighed paper towel. The wax deposit was weighed. The wax test was repeated in the presence and absence of hyperbranched polyether. The amount of hyperbranched polyether used was 600 ppm (added as solution of 10% polyether in Solvesso® 150 (mixture of aromatic hydrocarbons (aromatic content >99%), distillation range 182-207° C.) with respect to crude oil. The percent efficacy was calculated on the performance of paraffin inhibitor as compared to the baseline (i.e. the measurement without wax inhibitor). Each test was performed twice and the average of the two tests calculated.

| | Wax deposit of | Wax deposit of sample including | Inhibition |
|---|---|---|---|
| Sample | blind sample [g] | 600 ppm of inhibitor [g] | [%] |
| 1 | 3.05 | 0.79 | 74 |
| 2 | 3.05 | 1.10 | 64 |
| 3 | 3.05 | 1.47 | 52 |
| 4 | 3.05 | 1.06 | 65 |
| 5 | 3.70 | 1.16 | 69 |
| 6 | 3.70 | 2.07 | 44 |

1. A hyperbranched polyether of formula (I)
RₘQₙ-O—R¹ (I),
wherein
Q is a branching unit of formula 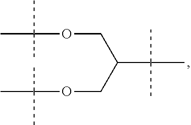
wherein the dashed lines indicate the connectivity to the rest of the molecule,
n is 2^{k}−1,
m is 2^{k},
k is 2, 3, 4, 5 or 6,
each R is independently a hydrocarbon radical having at least 10 carbon atoms,
R¹ is a polymer having a number average molecular weight Mₙ of at least 250 g/mol, wherein each branching unit Q is connected via ether linkage to adjacent branching units Q and each terminal oxygen of Q, not connected to adjacent branching units Q, is connected to R via ether linkage.

2. The hyperbranched polyether of claim 1, wherein k is 2 or 3.

3. The hyperbranched polyether of claim 1, wherein R is a hydrocarbon radical having 10 to 48 carbon atoms.

4. The hyperbranched polyether claim 1, wherein R is an alkyl group.

5. The hyperbranched polyether of claim 1, wherein R is an unbranched alkyl group.

6. The hyperbranched polyether of claim 1, wherein R¹ is a polymer having a number average molecular weight Mₙ in the range from 250 g/mol to 20000 g/mol.

7. The hyperbranched polyether of claim 1, wherein R¹ is connected to the oxygen in formula (I) via ester or carbamate group.

8. The hyperbranched polyether of claim 1, wherein R¹ comprises an alkylene chain of at least 10 chain carbon atoms.

9. The hyperbranched polyether of claim 8, wherein R¹ comprises —CH₂C(CH₃)₂— repeating units.

10. The hyperbranched polyether of claim 1, wherein R¹ comprises alkyleneoxy repeating units.

11. The hyperbranched polyether of claim 10, wherein R¹ comprises ethyleneoxy and/or propyleneoxy repeating units.

12. The hyperbranched polyether of claim 10, wherein R¹ comprises 5 to 200 repeating units.

13. A mixture of hyperbranched polyethers of claim 1.

14. A formulation comprising the hyperbranched polyether of claim 1 and a solvent.

15. A lubricating oil composition comprising
(a) at least one base oil component,
(b) the hyperbranched polyether of claim 1,
(c) optionally other additives.

16. Use of a hyperbranched polyether of claim 1 as wax inhibitor, as pour point depressant, as lubricant or in lubricating oils.

17. The hyperbranched polyether of claim 1, wherein k is 2.

18. The hyperbranched polyether of claim 2, wherein R is a hydrocarbon radical having 10 to 36 carbon atoms.

19. The hyperbranched polyether of claim 11, wherein R¹ comprises 10 to 150 repeating units.

20. A formulation comprising the mixture of claim 13 and a solvent.
